(19) United States
(12) Patent Application Publication
(10) Pub. No.: US 2020/0260828 A1
(43) Pub. Date: Aug. 20, 2020

(54) CONTACT LENS STORING DEVICE

(71) Applicant: Chin-Hung LIN, Taoyuan (TW)

(72) Inventor: Chin-Hung LIN, Taoyuan (TW)

(21) Appl. No.: 16/761,732

(22) PCT Filed: Nov. 7, 2018
(86) PCT No.: PCT/CN2018/114358

§ 371 Date: May 5, 2020

(30) Foreign Application Priority Data
Nov. 22, 2017 (CN) 201711172958.9

(51) Int. Cl. A45C 15/00; A45C 11/00; G02C 13/00

(52) U.S. Cl. CPC A45C 15/00; G02C 13/008; A45C 11/005

(57) ABSTRACT

A contact lens storing device (100) includes a casing (10) and a control unit (20). The casing (10) is formed with at least one accommodating space (12) for accommodating a contact lens and a contact lens care solution. The control unit (20) includes a control module (21), and a pair of electrodes (22) electrically connected to the control module (21) and disposed in the at least one accommodating space (12). The electrodes (22) and the control module (21) are operable to apply an electric current to the contact lens care solution accommodated in the at least one accommodating space (12) so as to generate an intermolecular interaction between the contact lens care solution and the contact lens. A method for storing a contact lens is also provided.

### FIELD

The disclosure relates to a contact lens storing device, more particularly to a contact lens storing device including a control unit having a control module and electrodes. The disclosure also relates to a method for storing a contact lens.

### BACKGROUND

With increasing numbers of people developing nearsightedness, the use of contact lenses is rising steadily due to its convenience. For this reason, the cleaning and hydration of contact lenses are becoming increasingly important issues, as microbes or contaminants on a dirty lens may cause infection of the eye, harming it. Further, wearing a lens having poor moisture retention may negatively impact the eye's health.

Conventional contact lenses are generally made of glass, silicone elastomer, silicone hydrogel, etc. When not worn, the contact lenses may be soaked in a contact lens care solution including a wetting agent to moisturize the contact lenses by letting the wetting agent in the care solution adhere to a surface of the contact lenses. However, the care solution may not be able to effectively adhere onto the contact lenses through simple soaking.

### SUMMARY

Therefore, an object of the disclosure is to provide a contact lens storing device that can improve the moisture retention of a contact lens stored therein. A method of storing the contact lens is also provided.

According to one aspect of the disclosure, a contact lens storing device includes a casing and a control unit.

The casing is formed with at least one accommodating space for accommodating a contact lens and a contact lens care solution.

The control unit is disposed on the casing. The control unit includes a control module spaced apart from the at least one accommodating space, and a pair of electrodes electrically connected to the control module and disposed in the at least one accommodating space.

The electrodes and the control module are operable to apply an electric current to the contact lens care solution accommodated in the at least one accommodating space so as to generate an intermolecular interaction between the contact lens care solution and the contact lens.

According to another aspect of the disclosure, a method for storing a contact lens includes:

soaking the contact lens into a contact lens care solution accommodated in an accommodating space formed in a casing of a contact lens storing device; and

applying an electrical current to the contact lens care solution to generate an intermolecular interaction between the contact lens and the contact lens care solution.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view of a first embodiment of a contact lens storing device according to the disclosure;

FIG. 2 is a perspective view of the first embodiment illustrating covers secured onto the contact lens storing device;

FIG. 3 is an exploded perspective view of a second embodiment of the contact lens storing device according to the disclosure; and

FIG. 4 is a process diagram of the method for storing contact lens.

### DETAILED DESCRIPTION

Before the present invention is described in greater detail, it should be noted that where considered appropriate, reference numerals or terminal portions of reference numerals have been repeated among the figures to indicate corresponding or analogous elements, which may optionally have similar characteristics.

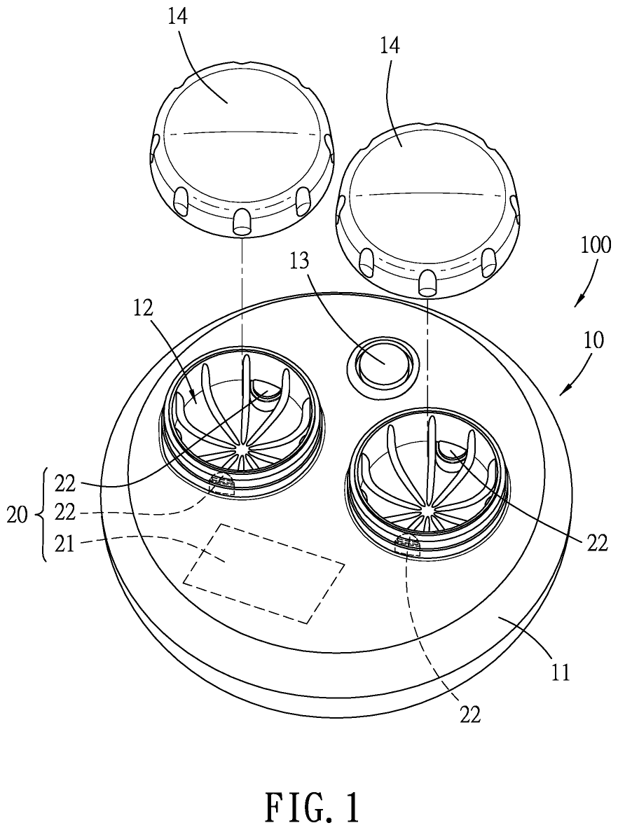

Referring to FIG. 1, a first embodiment of a contact lens storing device 100 according to the present disclosure includes a casing 10 and a control unit 20.

The casing 10 is formed with at least one accommodating space 12 for accommodating the contact lens and a contact lens care solution. In this embodiment, the casing 10 is exemplified to have a substantially circular shape and to be formed with two of the accommodating spaces 12 for receiving left-eye and right-eye contact lenses respectively. The two accommodating spaces 12 are not in fluidic communication with each other. The shape of the casing 10, the cross-section dimension and volume of the accommodating space 12, and the quantity of the accommodating space 12 can be adjusted to suit different needs and are not limited by this embodiment.

The control unit 20 is disposed on the casing 10, and includes a control module 21 spaced apart from the accommodating spaces 12 and at least one pair of electrodes 22 electrically connected to the control module 21. The control module 21 is a controller that can output an electrical current after being provided with electricity, or an electronic circuit that can provide an electrical current or an electrical voltage. In this embodiment, the control unit 20 includes two pairs of electrodes 22. Each pair of the electrodes 22 is disposed in a respective one of the accommodating spaces 12. The quantity of the electrodes 22 is not limited to four as in this embodiment. Each of the electrodes 22 may be made of an electrically conducting material, such as a metal. When the left-eye and right-eye contact lenses are respectively placed in the accommodating spaces 12 filled with the contact lens care solution, the electrodes 22 and the control module 21 are operable to apply an electrical current to the contact lens care solution accommodated in each of the accommodating spaces 12 so as to generate an intermolecular interaction between the contact lens care solution and the contact lenses, such as an electrostatic induction. As such, the moisture retention of the contact lens may be increased, thereby improving the comfort of the user while wearing the contact lenses. In the first embodiment, the control module 21 is electrically connected to a battery so as to receive external electricity.

As used herein, the term “contact lens care solution” may refer to any solution that has a wetting agent, examples may include but not limited to contact lens cleaners and soaking solutions.

The contact lens care solution may include saline; the wetting agent, such as hydroxypropul methyl cellulose (HPMC); and other additives, such as disodium ethylenediaminetetraacetate (disodium EDTA), poloxamer, polyaminopropyl biguanide, cyanocobalamin (vitamin B12), and combinations thereof.

More specifically, when the electric current is applied to the contact lens care solution accommodated in each of the accommodating spaces 12, intermolecular interaction between each of the contact lenses and the contact lens care solution would increase the amount of the wetting agent adhered to each of the contact lenses. For example, the increased amount of the wetting agent adhered to the contact lenses may occur based on the principle that when an object carrying electrostatic charge (i.e. an charged object) is proximal to an electrically neutral object, electrostatic induction causes the charge in the electrically neutral object to redistribute so that a charge opposite to a charge of the charged object develops on a side proximal to the charged object, while an equal and opposite charge develops on a side distal from the charged object. As opposite charges attract, the charged object and the electrically neutral object will experience an electrostatic attraction. In this embodiment, the contact lenses are electrically insulating and electrically neutral. The control module 21 being activated applies the electric current through the contact lens care solution accommodated in each of the accommodating spaces 12, causing the wetting agent in the contact lens care solution to become charged. The charged wetting agent can then adhere to the electrically neutral contact lens received in each of the accommodating spaces 12 through electrostatic induction and attraction. The increased adherence of the wetting agent in the contact lens care solution to the contact lens improves the moisture retention of the contact lens.

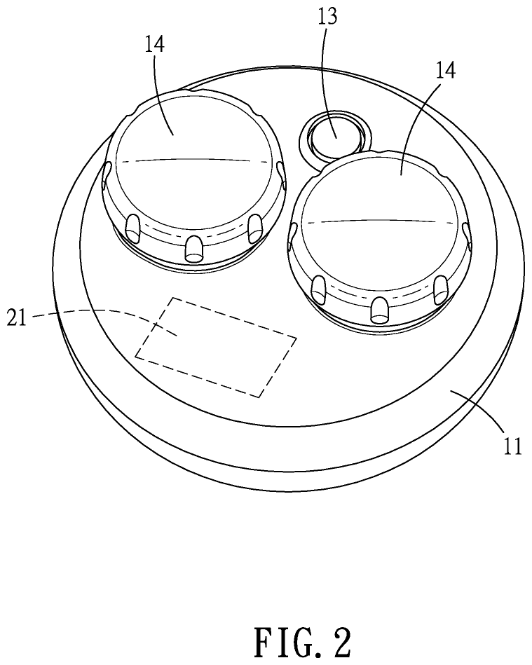

Referring to FIG. 2, the contact lens storing device 100 further includes a switch member 13 disposed on the casing 10 and at least one a cover member 14 removably covering the at least one accommodation space 12. The quantity of cover member 14 is equal to that of the accommodating space 12. In this embodiment, there are two of the cover members 14 to removably cover the two accommodation spaces 12, respectively. The switch member 13 is electrically connected to the control module 21 and operable to turn on or turn off the control module 21, such that the control module 21 may correspondingly output or stop outputting the electrical current.

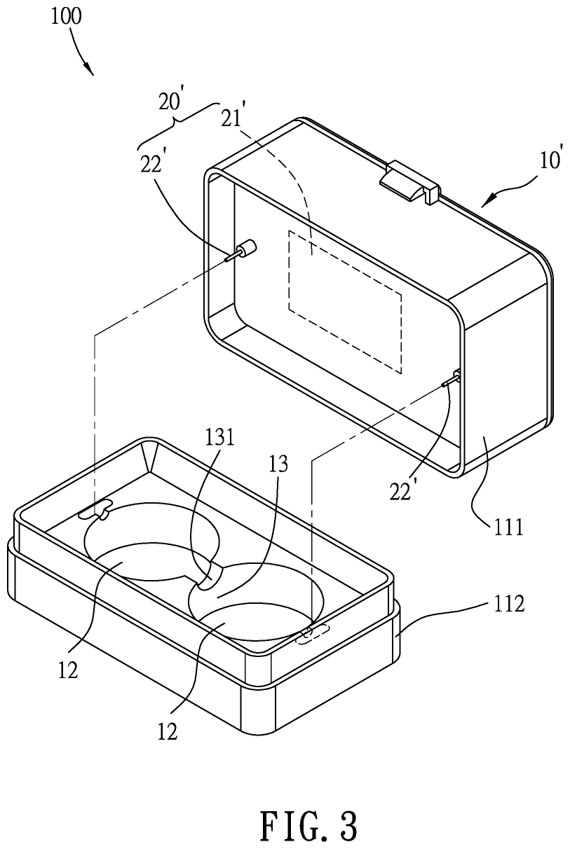

Referring to FIG. 3, a second embodiment of the contact lens storing device 100 includes a housing 10′ and a control unit 20′. In this embodiment, the casing 10′ has a substantially rectangular shape and includes an upper casing part 111 and a lower casing part 112 detachably connected to the upper casing part 111. The lower casing part 112 of the casing 10′ is formed with the at least one accommodating space 12. In this embodiment, the lower casing part 112 is formed with two of the accommodating spaces 12 and a separation wall 13 disposed between the accommodating spaces 12. Each of the accommodating spaces 12 is adapted to accommodate left-eye and right-eye contact lenses, respectively, and the contact lens care solution. The separation wall 13 is formed with a groove 131 that is in spatial communication with the accommodating spaces 12 so that the accommodating spaces 12 are in fluidic communication with each other.

The second embodiment includes a control unit 20′ is disposed on the upper casing part 111 of the casing 10′, and includes a control module 21′ and two electrodes 22′. The functions of the control module 21′ and the electrodes 22′ are identical to those in the first embodiment, and thus would not be further discussed here. In this embodiment, the electrodes 22′ project from the upper casing part 111 of the casing 10′, such that when the upper casing part 111 and the lower casing part 112 of the casing 10′ connects, the electrodes 22′ are inserted into the accommodating spaces 12, respectively, to apply the electrical current to the contact lens care solution accommodated in the accommodating spaces 12 in cooperation with the control module 21′.

Similar to the first embodiment, after the control module 21′ is turned on and applies a current to the contact lens care solution through the electrodes 22′, large amounts of the wetting agent in the care solution may be adhered to the contact lenses through intermolecular interactions, enhancing the moisture retention of the contact lens as the contact lenses soaks and cleans.

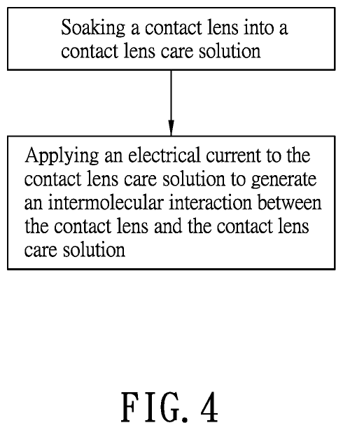

Referring to FIG. 4, a method for storing a contact lens according to the present disclosure, which may be used with a contact lens storing device 100 described in the above embodiments, is disclosed.

The method for storing a contact lens includes soaking a contact lens into a contact lens care solution; and providing the contact lens care solution with an electrical current to generate an intermolecular interaction between the contact lens and the contact lens care solution.

When used with the contact lens storing device 100 described in the above embodiments, the method for storing a contact lens may further include disposing in the at least one accommodating space 12 the pair of electrodes 22, 22′ electrically connected to a control module 21, 21′. The electrodes 22, 22′ and the control module 21, 21′ are operable to apply the electrical current to the contact lens care solution.

In this embodiment, the duration that the electrical current is applied to the contact lens care solution is 30 second, but the method is not limited in this respect.

In sum, through the electrostatic interactions between the electrically neutral contact lens and the charged wetting agent of the contact lens care solution, the moisture retention of the contact lens is improved, thereby improving the comfort of the user of the contact lens.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A contact lens storing device comprising:
a casing formed with at least one accommodating space for accommodating a contact lens and a contact lens care solution; and
a control unit disposed on said casing, said control unit including a control module spaced apart from said at least one accommodating space, and a pair of electrodes electrically connected to said control module and disposed in said at least one accommodating space,
wherein said electrodes and said control module are operable to apply an electric current to the contact lens care solution accommodated in the at least one accommodating space so as to generate an intermolecular interaction between the contact lens care solution and the contact lens.

2. The contact lens storing device of claim 1, wherein said casing includes an upper casing part and a lower casing part detachably connected to said upper casing part, said lower casing part formed with said at least one accommodating space, said control module of said control unit being disposed on said upper casing part, and said electrodes of said control unit projecting from said upper casing part and being inserted into said at least one accommodating space when said upper casing part is connected to said lower casing part.

3. The contact lens storing device of claim 2, wherein said lower casing part is formed with two of said accommodating spaces and a separation wall disposed between said accommodating spaces, said separation wall being formed with a groove that is in spatial communication with said accommodating spaces so that said accommodating spaces are in fluidic communication with each other; and wherein said electrodes are inserted into said accommodating spaces, respectively, when said upper casing part is connected to said lower casing part.

4. The contact lens storing device of claim 1, further comprising a switch member disposed on said casing and electrically connected to said control module, said switch member being operable to turn on or turn off said control module.

5. The contact lens storing device of claim 1, further comprising at least one cover member removably covering said at least one accommodating space.

6. The contact lens storing device of claim 5, wherein said at least one accommodating space includes a plurality of spaced-apart accommodating spaces, said at least one cover member including a plurality of cover members, each of said cover members removably covering a corresponding one of said spaced-apart accommodating spaces.

7. A method for storing a contact lens, comprising:
soaking the contact lens into a contact lens care solution accommodated in an accommodating space formed in a casing of a contact lens storing device; and
applying an electrical current to the contact lens care solution to generate an intermolecular interaction between the contact lens and the contact lens care solution.

8. The method of claim 7, further comprising disposing in the accommodating space a pair of electrodes electrically connected to a control module, the electrodes and the control module being operable to apply the electrical current to the contact lens care solution.
